(19) United States
(12) Patent Application Publication
(10) Pub. No.: US 2009/0118856 A1
(43) Pub. Date: May 7, 2009

(54) Status indication method and status indication system

(75) Inventors: Takahiro Nakagawa, Kanagawa (JP); Masashi Tsuyama, Kanagawa (JP); Shigeto Nishiuchi, Kanagawa (JP); Youichi Nonaka, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 12/287,222

(22) Filed: Oct. 6, 2008

(30) Foreign Application Priority Data
Oct. 4, 2007 (JP) 2007-261116

(51) Int. Cl. G06F 19/00; G06Q 10/00

(52) U.S. Cl. 700/108; 705/7

(57) ABSTRACT

Embodiments of the present invention provide a method and system for solving a location designation problem to give specific instructions to workers as to where the device that has completed processing is in the production site, and a setup starting time designation problem to give instructions to workers as to when the setup for operation after a test is completed is conducted. One embodiment includes a means for recognizing the processing progress statuses of the devices in the production site, means for indicating the processing progress statuses of the devices, means for predicting the processing completion times of the devices, and means for indicating when a preparation (setup operation) is started for a particular device. A worker receives the processing progress statuses of the respective devices of the respective units from the means for indicating the processing progress statuses of the devices, and records the time to carry in the works to be placed in the devices to the devices and start placement from the means for indicating when a setup operation is started for a particular device.

### CROSS-REFERENCE TO RELATED APPLICATION

The instant nonprovisional patent application claims priority to Japanese Patent Application No. 2007-261116 filed Oct. 4, 2007 and which is incorporated by reference in its entirety herein for all purposes.

### BACKGROUND OF THE INVENTION

In mass-production manufacturing of home electronics, semiconductor devices, magnetic storage devices, printed circuit boards, etc., automated manufacturing systems such as robots and machine tools may perform manufacturing by treatment with chemical reaction, microfabrication, microassembly, or the like because it is difficult for workers to conduct operation directly. In the automated manufacturing systems, robots and machine tools may conduct main operations and workers may conduct supplementary operations such as carrying in and carrying out of works and setup operations.

For example, in manufacturing of magnetic storage devices, products are completed in the following manner: assembly operation of a plurality of magnetic heads and magnetic disks with other parts such as spindle motors and frames is conducted by a special robot system; the assembled works are collected and transported by workers to the testing process as a subsequent process; and then, the magnetic characteristics and storage capacity of the works are tested by automated equipment.

Further, in printed circuit boards, products are completed in the following manner: minute electronic parts such as semiconductor chips and capacitors are arranged on printed circuit boards by an automatic machine and automatically bonded and cured in a solder reflow furnace; then, the printed circuit boards are collected and transported by workers to the testing process as a subsequent process; and electric tests are conducted by an automatic machine.

In the above described manufacturing, raising productivity of the automated manufacturing system is an important challenge in view of investment recovery. Assuming that the improvement in productivity is defined as production output per unit time, reduction of main operation time and reduction of supplementary operation time must be achieved for improvement in productivity. Especially, in the automated manufacturing system, there is an important challenge in reducing supplementary operation time including reducing failure frequency, setup operation time, waiting time for the works to stay until the works can be carried into the process, and the like.

For example, in manufacturing of magnetic storage devices, their magnetic characteristics and storage capacity may be tested by plural continuous automated manufacturing systems. For the test, conventionally, there has been a batch operation method of inputting a batch of several tens to several hundreds of magnetic storage devices to a testing device and conducting a test thereon, and inputting the batch to a testing device in the next process conducting a test thereon. In this regard, there has been (1) a problem of magnetic storage device characteristics that even magnetic devices having the same capacity need different test times due to individual performance difference in reading and writing, and (2) an operation problem that the magnetic storage devices can not be carried out until the test of a predetermined amount or more of them relative to the entire number of magnetic storage devices have been finished. Because of the problems (1) and (2), when workers should go to the testing device and conduct, operation is unpredictable and the magnetic storage devices wait for being carried out within the testing device after the test is finished, and therefore, there has been a problem that supplementary operation time becomes longer and the problem causes inhibition of improvement in productivity of the automated manufacturing system.

Further, there is an individual operation method of inputting magnetic storage devices one by one to a testing device and conducting a test thereon, and inputting them one by one to a testing device in the next process and conducting a test thereon other than the above described batch operation method. Furthermore, there is an automated manufacturing system containing a collection of several tens to several thousands of testing devices and transporting magnetic storage devices one by one with a robot handler and conducting tests using the method. In the automated manufacturing system, when an exceptional operation such as system emergency stop is conducted, the restoration procedure varies depending on the test progress statuses of the individual magnetic storage devices. On the other hand, because of the above described problem (1), unless the test times of the individual magnetic storage devices are constantly recognized, there is a problem the restoration operation takes time and the supplementary operation time becomes longer and the problem causes inhibition of improvement in productivity of the automated manufacturing system.

As described above, to reduce the supplementary operation time, an important challenge is to constantly recognize the manufacturing progress of individual works in the process and when, where, and what operations should be conducted by workers can be predicted depending on the statuses. Regarding the challenge, Japanese Patent Publication No. 2007-18447 (“Patent Document 1”) proposes a method of indicating the test progress statuses of magnetic storage devices with lighting indicators provided in the respective testing devices. Japanese Patent Publication No. 2007-122251 (“Patent Document 2”) proposes a method of collectively managing the progress information of recording medium creating processing of magnetic storage devices with a computer, and indicating the progress statuses in colors or textures on representation that reproduces the shape of the recording media on the indicator of the computer is proposed. Further, Japanese Patent Publication No. 2002-366222 (“Patent Document 3”) proposes a method of predicting the time to be taken for measurement tests by comparing, with respect to the progress statuses of the wafer measurement tests, the ratio of acceptable chips (yield) within a wafer in the process and the measurement time that has been taken so far with the past measurement test records, and using the time for making the schedule of the entire production system.

In the above described patent document 1, there is a problem that the status can not be recognized unless workers see around the individual testing devices. Especially, in a production site in which several thousands of devices are provided in parallel, there is a problem determining which device is under what condition of the progress status.

Further, in the patent document 2, there is a problem that no specific indicating means for indicating the location within the production site in block number. Especially, in a production site in which several thousands of devices are provided in parallel, there is a problem determining which device is under what condition of the progress status.

In the patent document 3, there is a problem that instructions can not be given to workers in advance when to conduct setup for operation after completion of processing of devices. The setup here includes an operation of confirming whether works can be input to the next process of the test process of interest, an operation of collecting and carrying in the next works to be input. There is a challenge that these setup operations are started at appropriate times and the next operations are immediately conducted when the tests are completed for suppressing the extension of the supplementary operation time.

### BRIEF SUMMARY OF THE INVENTION

Embodiments of the present invention provide a method and system for solving a location designation problem to give specific instructions to workers as to where the device that has completed processing is in the production site, and a setup starting time designation problem to give instructions to workers as to when the setup for operation after a test is completed is conducted.

As shown in FIG. 1, one embodiment includes means (104) for recognizing the processing progress statuses of the devices (103) in the production site (101), means (105) for indicating the processing progress statuses of the devices, means (106) for predicting the processing completion times of the devices, and means (107) for indicating when a preparation (setup operation) is started for a particular device. A worker receives the processing progress statuses of the respective devices (103) of the respective units (102) from the means (105) for indicating the processing progress statuses of the devices, and records the time to carry in the works (109) to be placed in the devices (103) to the devices (103) and start placement from the means (107) for indicating when a setup operation is started for a particular device.

### BRIEF DESCRIPTION OF THE DRAWINGS

FIG. 1 is a diagram showing schematic procedure of an embodiment of the invention.

FIG. 2 is a diagram showing an example of a process flow to which an embodiment of the invention is applied.

FIG. 3 is a graph showing processing times of works to which an embodiment of the invention is applied.

FIG. 4 is a graph showing processing times of works to which an embodiment of the invention is applied.

FIG. 5 is a graph showing times to start the setup operation of works to which an embodiment of the invention is applied.

FIG. 6 is a chart showing a procedure of status indication in an automated manufacturing system according to an embodiment of the invention.

FIG. 7 is a diagram showing an indication example of the processing progress status of the device in an embodiment of the invention.

FIG. 8 is a diagram showing another example of a process flow to which an embodiment of the invention is applied.

FIG. 9 is a diagram showing an indication example of the processing progress status of the device in the example shown in FIG. 8.

FIG. 10 is a diagram showing a specific procedure when the invention is applied to the manufacturing of magnetic recording devices (HDD).

FIG. 11 is a diagram showing a system configuration example of an automated manufacturing system implementing an embodiment of the invention.

### DETAILED DESCRIPTION OF THE INVENTION

Embodiments of the present invention provide a method and system for improvement in production efficiency for mass-production manufacturing of home electronics, semiconductor devices, magnetic storage devices, printed circuit boards, etc.

Embodiments of the invention are capable of raising productivity of an automated manufacturing system, focuses its attention on reduction of supplementary operation time, and provides a status indication technology of devices to solve (A) location designation problem to give specific instructions to workers as to where the device that has completed processing is in the production site, and (B) setup starting time designation problem to give instructions to workers when to conduct the setup for operation after a test is completed.

A representative status indication method of embodiments of the invention is a status indication method for managing a starting time of a setup operation in an automated manufacturing system in which setup of a plurality of devices placed in a production site is conducted by a worker or an automatic machine, and includes:

the step of recognizing locations within the production site and processing progress statuses from said plurality of devices;

the step of indicating the locations and the processing progress statuses of the plurality of devices recognized in said step;

the step of predicting starting times of the setup operation for an operation after processing is completed from the processing progress statuses of said plurality of devices recognized in said step; and

the step of indicating the starting times of the setup operation predicted at said step.

According to embodiments of the invention, since an instruction as to where the device in which processing is completed is in the production site can be given to the worker, the worker can reach the device to be operated without getting lost, and finish the setup at the time when the processing of the device is completed and immediately carry out the completely processed works and carry in new works. Therefore, the supplementary operation time can be reduced and the reduction contributes to improvement in productivity of the automated manufacturing system.

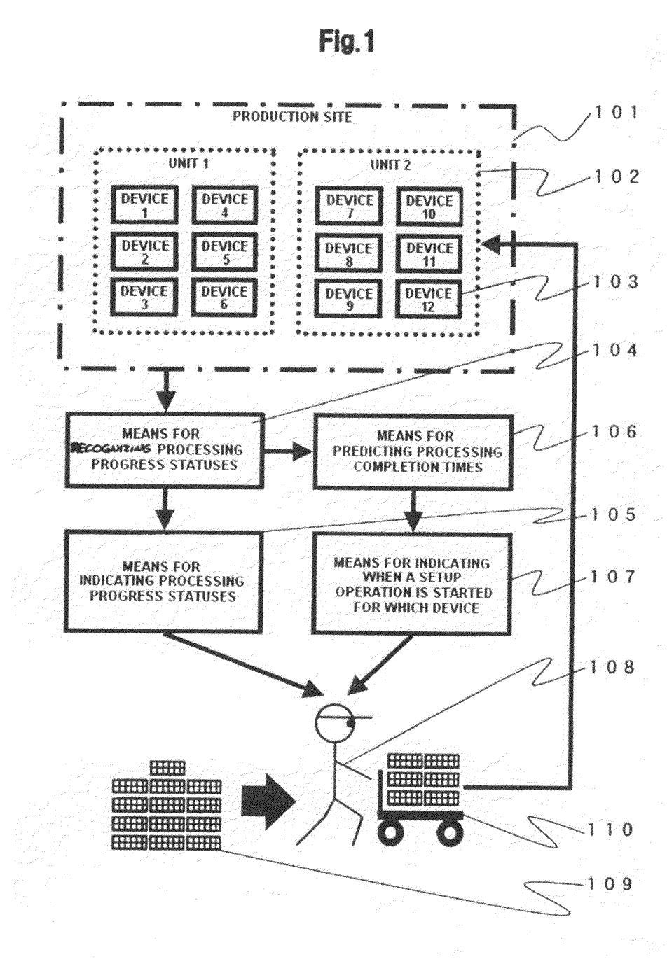

First, a schematic procedure of embodiments of the invention will be described with reference to FIG. 1. In a production site (101), there are devices (103) in the same specifications for certain processing. One work is placed for processing in each device (103). A plurality of devices (103) are provided together in a unit (102). The unit is a system that performs integrated management of power supplies and temperatures of the devices (103). The works are placed in the devices (103) in terms of the units, and the works are carried out from the devices (103) in terms of the units. That is, when processing is completed in one device but not completed in another device within the same unit, the completely processed work can not be carried out from the device but wait for being carried out.

In embodiments of the invention, means (104) for recognizing the processing progress statuses of the devices (103) in the production site (101), means (105) for indicating the processing progress statuses of the devices, means (106) for predicting the processing completion times of the devices, and means (107) for indicating when a preparation (setup operation) are started for which devices are provided. A worker (108) receives the processing progress statuses of the respective devices (103) of the respective units (102) from the means (105) for indicating the processing progress statuses of the devices, and records the times to carry in the works (109) to be placed in the devices (103) with a cart (110) to the devices (103) and start placement from the means (107) for indicating when a setup operation is started for which device.

That is, carrying in and carrying out of the works (109) to the devices (103) can be performed in synchronization with the processing completion times by the means (107) for indicating when a setup operation is started for which device, and the location where a work in which device (103) of which unit (102) is carried out and a new work (109) is carried in and placed can be known by the means (105) for indicating the processing progress statuses of the devices, and thus, supplementary operation time can be reduced.

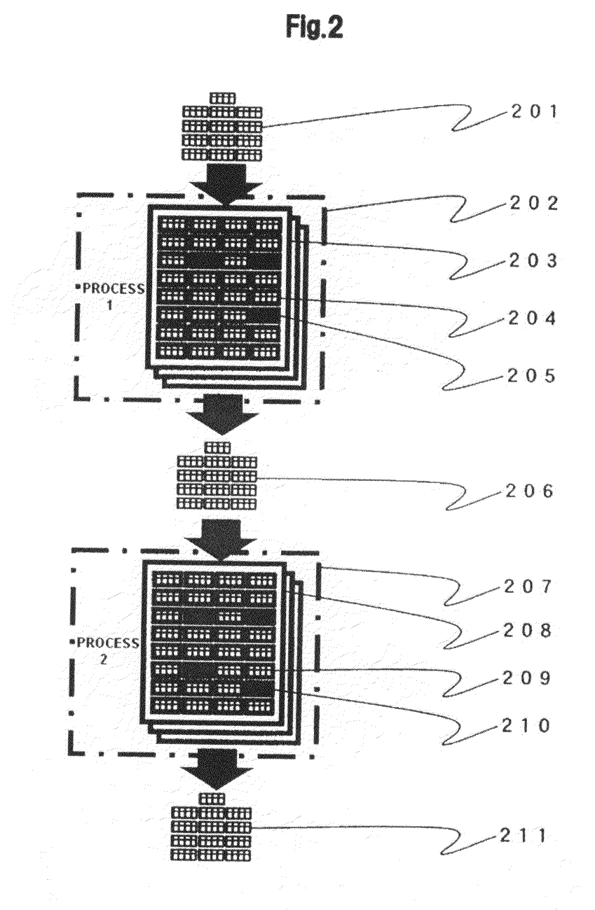

FIG. 2 shows a process flow applied to the schematic procedure shown in FIG. 1. In the process flow, works (201) are carried in to process 1 (202), works (206) carried out from process 1 (202) are carried in to process 2 (207), and finally, works (211) are carried out from process 2 (207).

A plurality of units (203) are provided in process 1, and a plurality of devices (204) are provided in each unit (203). Here, the devices (204) in which works are placed are shown by squares with grid pattern, and devices (205) without works in the idol state are shown by black squares. The works are placed in the devices (204) in terms of the units (203) and the works are carried out from the devices (204) in terms of the units (203). That is, when processing is completed in one device but not completed in another device within the same unit, the completely processed work can not be carried out from the device but wait for being carried out.

Similarly, a plurality of units (208) are provided in process 2, and a plurality of devices (209) are provided in each unit (208). Here, the devices (209) in which works are placed are shown by squares with grid pattern, and devices (210) without works in the idol state are shown by black squares. The works are placed in the devices (209) in terms of the units (208) and the works are carried out from the devices (209) in terms of the units (208). That is, when processing is completed in one device but not completed in another device within the same unit, the completely processed work can not be carried out from the device but wait for being carried out.

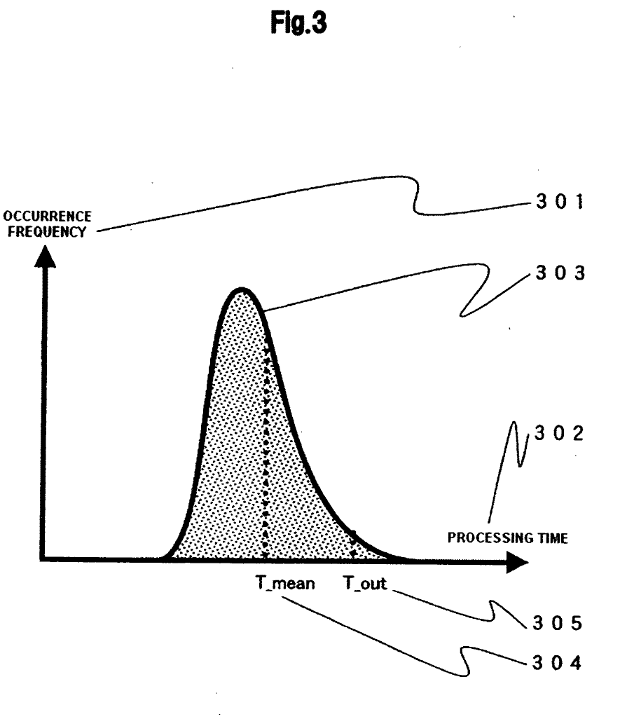

FIG. 3 shows processing times of works in the devices (103) in the schematic procedure shown in FIG. 1. For example, in the test process of magnetic storage devices, there is a problem that actual processing times vary though the standard processing time is determined because of a problem of magnetic storage device characteristics that even magnetic devices having the same capacity need different test times due to individual performance difference in reading and writing. FIG. 3 shows a variation distribution (303) of processing time with the processing time (302) along the horizontal axis and the occurrence frequency (301) for each processing time along the vertical axis. The standard processing time (304) is shown by T_mean in the graph and there are variations around the T_mean as in the graph. Especially, processing of a magnetic storage device at the longer processing time takes forever and not completed due to the characteristics of magnetic storage device, and thus, for the actual devices, the processing ending time (305) is set and the processing is forcibly ended, and the completely processed works are carried out as normal products and the incompletely processed works are carried out as products requiring reprocessing.

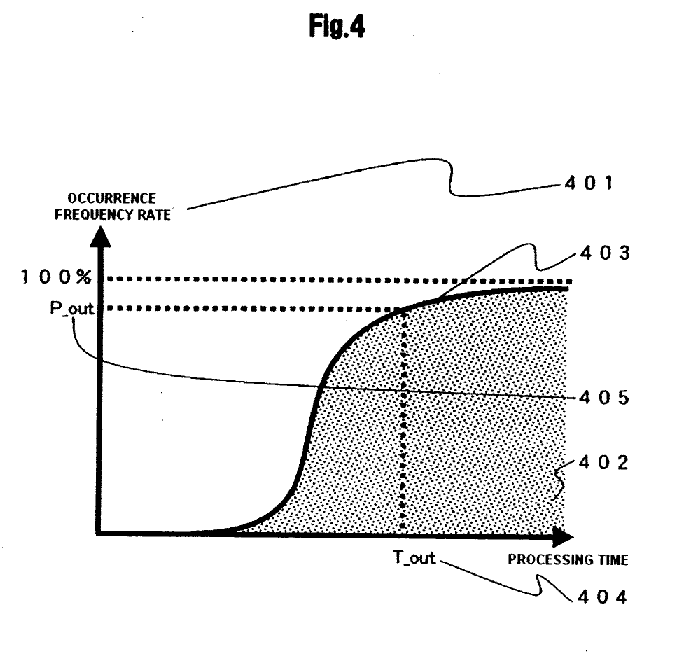

FIG. 4 shows a graph in which the variations of processing time shown in FIG. 3 are rewritten with the cumulative occurrence frequency rate when the plurality of devices are considered in terms of units in which the devices are collectively provided. FIG. 4 shows a variation distribution (403) of processing time with the processing time (402) along the horizontal axis and the occurrence frequency rate (401) for each processing time along the vertical axis. As described by referring to FIG. 3, in the devices, the processing ending time (404) is set and the processing is forcibly ended, and the completely processed works are carried out as normal products and the incompletely processed works are carried out as products requiring reprocessing. As a result, the ratio of the completely processed works do not reach 100% in the unit, but becomes the ratio P_out less than 100%.

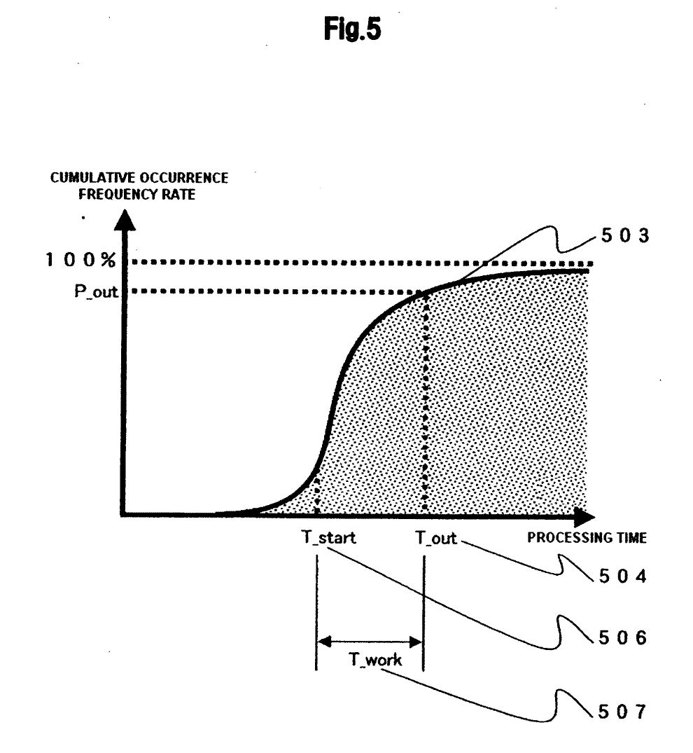

FIG. 5 is a graph of cumulative occurrence frequency rate of variations of processing time in terms of units in FIG. 4, and shows the time (506) when the worker (108) in FIG. 1 starts a setup operation by T_start. That is, the processing ending time (504) is estimated from the variation distribution (503), and the time (506) to start the setup operation is calculated by subtracting a time (507) required for the setup operation from the time.

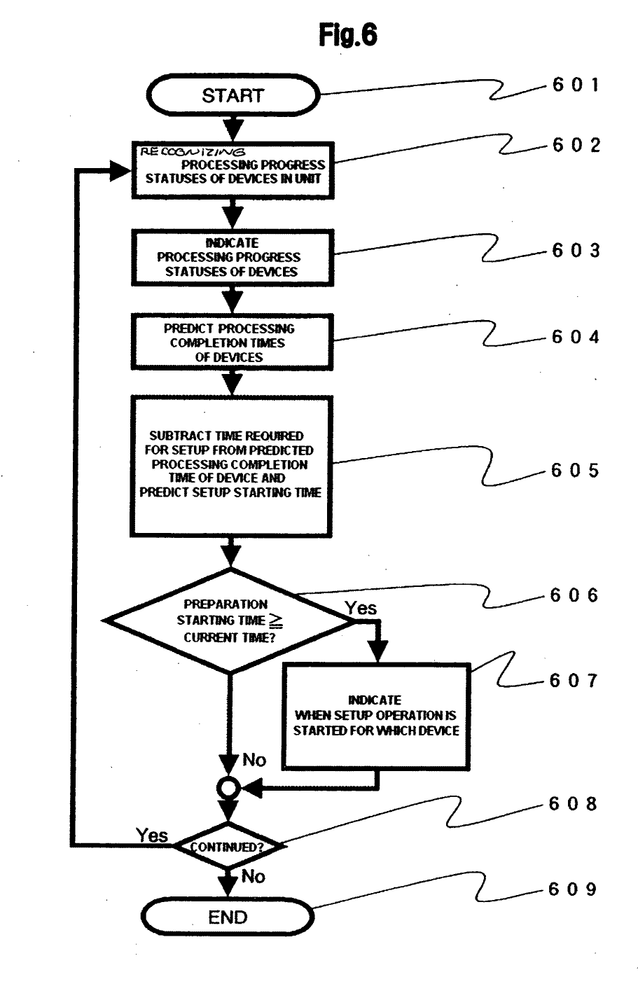

FIG. 6 is a flowchart of a status indication method in an automated manufacturing system according to an embodiment embodying the procedure shown in FIG. 1. When the automated manufacturing system is started to activate at START step (601), first, the processing progress statuses of a device in a unit are recognized (602). The processing progress statuses of the devices are indicated (603), and the processing completion time (404) of the devices is predicted from the variation distribution (403) of processing time as shown in FIG. 4 (604). Then, as shown in FIG. 5, the time required for setup is subtracted from the predicted processing completion time of the device and the setup starting time is predicted (605). Subsequently, when the current time becomes the same as or pasts the setup starting time (606), a setup operation is started for which device is indicated (607). Then, whether the activation of the automated manufacturing system is continued or not is determined (608), and if continued, the process returns to step (602) of recognizing the processing progress of the devices in the unit again. If the activation is not continued, the process moves to END step (609) and the system is ended.

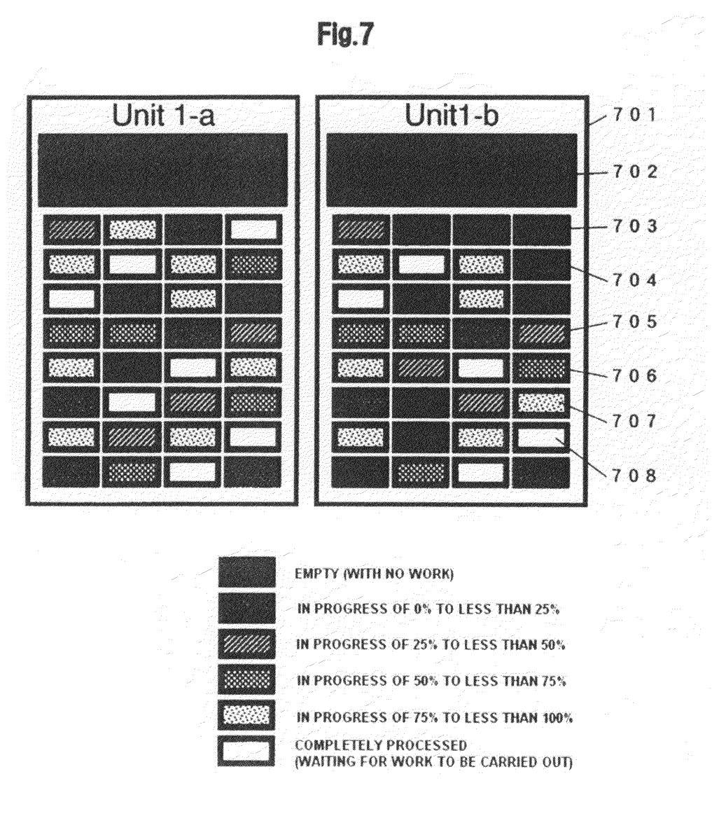

FIG. 7 shows an indication example in the step (603) of indicating the processing progress statuses of the status indication method shown in FIG. 6. The indication is configured in terms of units (701), and configured by areas (702) that indicate how many hours are required for processing from now in the respective units and areas (703, 704, 705, 706, 707, 708) that indicate processing statuses of the devices within the units in scale. The position of the device in the area that indicates the processing status of the device shows the actual position of the device in scale within the unit. The processing progress of the device is represented by the square background showing the device with colors or textures. For example, the empty device with no work is indicated as shown by 703, the device in progress of 0% to less than 25% is indicated as shown by 704, the device in progress of 25% to less than 50% is indicated as shown by 705, the device in progress of 50% to less than 75% is indicated as shown by 706, the device in progress of 75% to less than 100% is indicated as shown by 707, and the completely processed device waiting for work to be carried out is indicated as shown by 708.

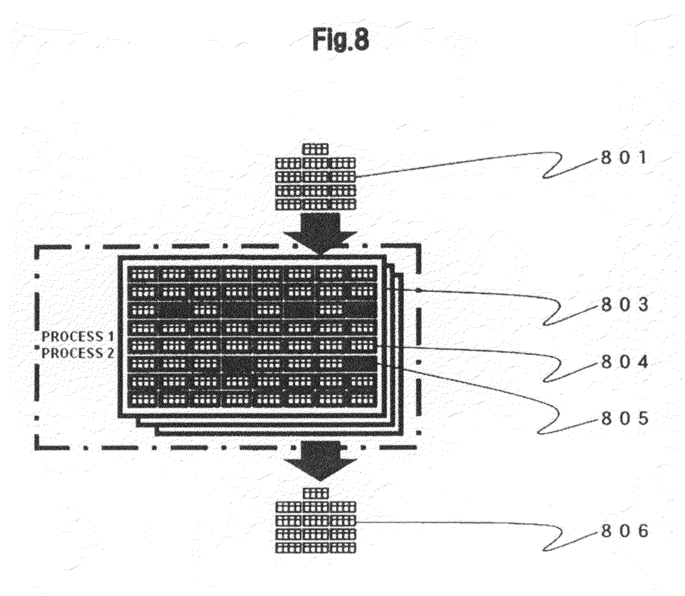

FIG. 8 shows a process flow different from that in FIG. 2. In the process flow, the process 1 (202) and the process 2 (207) in FIG. 2 are processed in the same unit (803). The unit (803) is provided with a plurality of devices and the devices with work are shown by squares with grid pattern (804), and devices without work are shown by black squares (805). Works (801) are carried into the unit (803), processing in the process 1 and process 2 is conducted thereon and carried out, and thus, works (806) are formed.

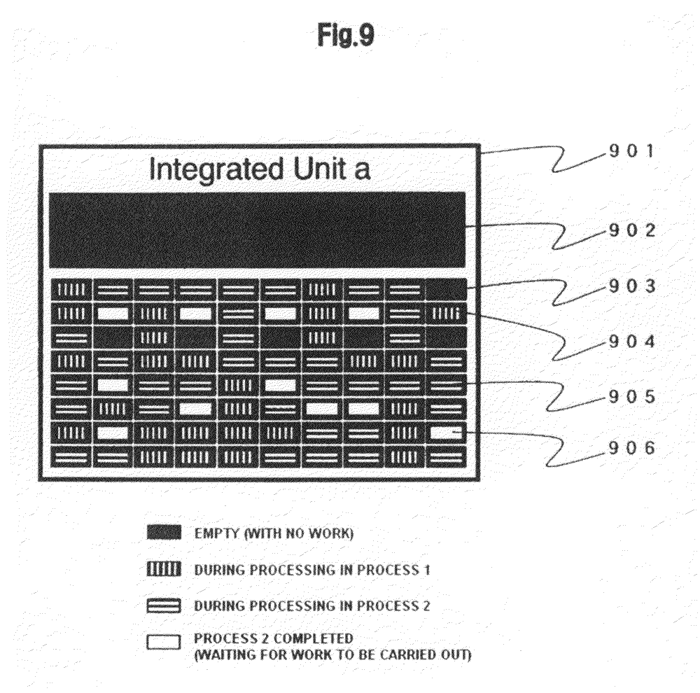

FIG. 9 shows an indication example in the step (603) of indicating the processing progress statuses of the status indication method shown in FIG. 6. The indication is configured in terms of units (901), and configured by areas (902) that indicate how many hours are required for processing from now in the respective units and areas (903, 904, 905, 906) that indicate processing statuses of the devices within the units in scale. The position of the device in the area that indicates the processing status of the device in scale shows the actual position of the device within the unit. The processing progress of the device is represented by the square background showing the device with colors or textures. For example, the empty device with no work is indicated as shown by 903, the device during processing in the process 1 is indicated as shown by 904, the device during processing in the process 2 is indicated as shown by 905, and the completed device in the process 2 waiting for work to be carried out is indicated as shown by 906.

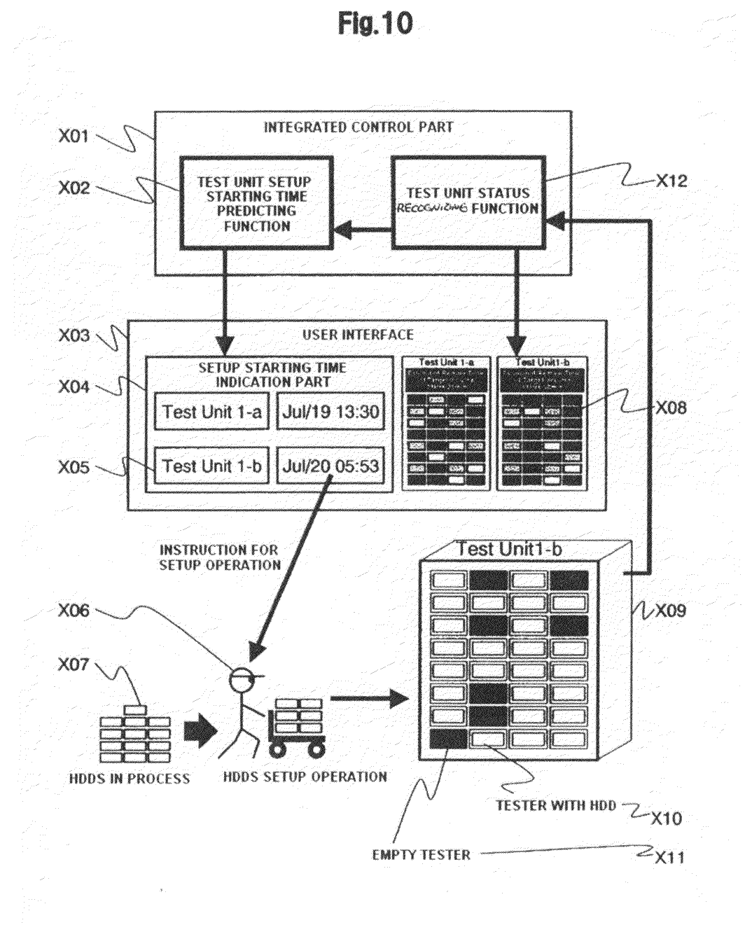

FIG. 10 shows an example showing a specific procedure when the above described status indication method is applied to the manufacturing of magnetic recording devices (Hard Disk Drive: HDD). In a test unit 1-b (X09), there are testers (X10) with HDD and empty testers (X11), and the performance test of HDD is conducted in the testers (X10) with HDD. Regarding the empty statuses and test progress of these testers, which tester in which test unit contains an HDD and to what degree the test progress of the tester containing the HDD is, are recognized by a test unit status recognizing function (X12) in an integrated control part (X01). The recognized result is indicated in a test progress indication part (X08) of a user interface (X03), and which tester contains an HDD and to what degree the test progress of the tester containing the HDD is, are indicated to a worker (X06). Using the information of test progress, the setup starting time of each test unit is predicted by a test unit setup starting time predicting function (X02). Then, the setup starting time of each test unit is displayed in a test unit 1-b indication part (X05) of a setup starting time indication part (X04) of the user interface (X03) and an instruction of the setup operation starting time is given to the worker (X06).

According to the instruction, the worker (X06) transports HDDs to be newly tested from HDDs in process (X07) to the test unit 1-b (X09), takes out the completely processed HDDs, and places the HDDs to be newly tested. The setup operation including transportation, taking out, and placement takes time. Conventionally, the setup operation is started at the time when the test unit 1-b (X09) is ended, for example, and the test unit 1-b (X09) waits for the completion of the setup operation in the setup operation time, and thereby, the productivity is lowered. On the other hand, in an embodiment of the invention, the test ending time is predicted, the setup starting time is predicted therefrom, and then, the setup operation is started. Therefore, the test unit 1-b (X09) does not need to wait for the completion of the setup operation, and the productivity is no longer lowered.

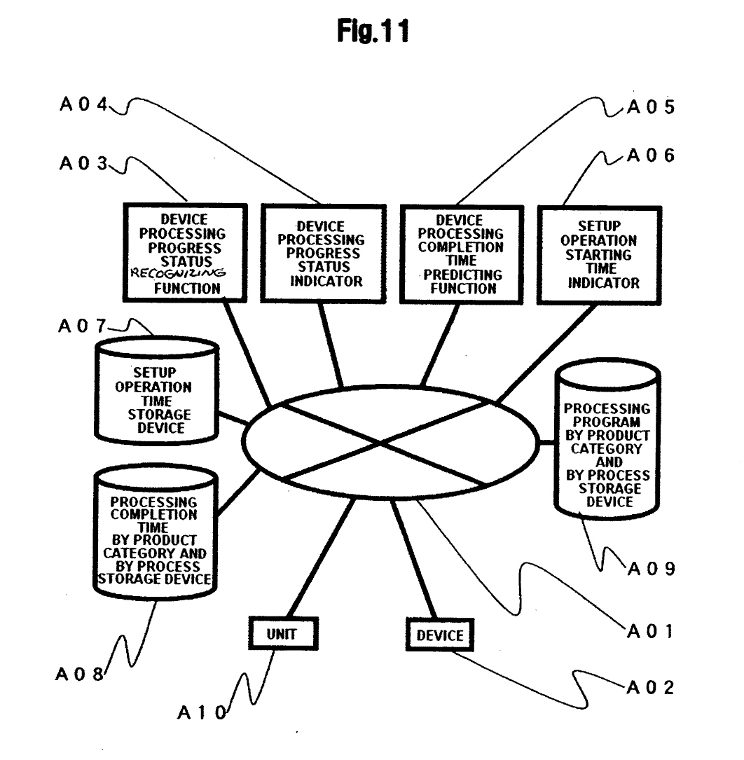

FIG. 11 shows a system configuration example of an automated manufacturing system implementing an embodiment of the invention. The system configuration is a configuration that realizes the specifications described by referring to FIGS. 1 to 6. With a network (A01) centered, a device (02), a unit (A10), a device processing progress status recognizing function (A03), a device processing progress status indicator (A04), a device processing completion time predicting function (A05), a setup operation starting time indicator (A06), a setup operation time storage device (A07), a processing completion time by product category and by process storage device (A08), a processing program by product category and by process storage device (A09) are connected. The program processed in the device (A02) is appropriately transmitted from the processing program by product category and by process storage device (A09), variation distribution information of processing completion time is transmitted from the processing completion time by product category and by process storage device (A08) to the device processing completion time predicting function (A05), and setup operation time information is transmitted from the setup operation time storage device (A07) to the setup operation starting time indicator (A06). Here, the device processing progress status recognizing function (A03), the device processing completion time predicting function (A05), and the prediction of setup operation starting time can be realized by a processing device such as a computer.

What is claimed is:

1. A status indication method for managing a starting time of a setup operation in an automated manufacturing system in which setup of a plurality of devices placed in a production site is conducted by a worker or an automatic machine, the status indication method comprising:
recognizing locations within the production site and processing progress statuses from said plurality of devices;
indicating the locations and the processing progress statuses of the plurality of devices recognized;
predicting starting times of the setup operation for an operation after processing is completed from the processing progress statuses of said plurality of devices recognized; and
indicating the starting times of the setup operation predicted.

2. The status indication method according to claim 1, wherein predicting starting times of the setup operation includes:
predicting processing completion times of said plurality of devices from the processing progress statuses of said plurality of devices and processing completion times by product category and by process saved in advance; and
predicting the starting times of the setup operation for the devices from the processing progress statuses of said plurality of devices and a time required for the setup operation for processing of the devices saved in advance.

3. The status indication method according to claim 2, wherein predicting processing completion times of said plurality of devices predicts a completion time of processing from a variation distribution of processing time of said plurality of devices.

4. The status indication method according to claim 1, wherein said plurality of devices are testing devices.

5. The status indication method according to claim 1, wherein indicating the locations and the processing progress statuses of said plurality of devices indicates the actual locations of said plurality of devices in scale and the processing progress statuses of said plurality of devices by varying colors or textures of the scaled indication.

6. The status indication method according to claim 1, wherein predicting starting times of the setup operation includes:
collectively starting processing of said plurality of devices;
uniformly determining the time at which the processing is ended in said set to be collectively processed;
conducting ending processing of said set at a certain time from said processing ending time uniformly determined; and
calculating the time to start the setup operation for the processing by subtracting the time required for the setup operation for the processing from said starting time of the ending processing.

7. A status indication system for managing a starting time of a setup operation in an automated manufacturing system in which setup of a plurality of devices placed in a production site is conducted by a worker or an automatic machine, the status indication system comprising:
means for recognizing locations within the production site and processing progress statuses from said plurality of devices;
means for indicating said recognized locations and processing progress statuses of the plurality of devices;
means for predicting starting times of the setup operation for an operation after processing is completed from said recognized processing progress statuses of the plurality of devices; and
means for indicating said predicted starting times of the setup operation.

8. The status indication system according to claim 7, wherein said means for predicting starting times of the setup operation includes:
means for predicting processing completion times of said plurality of devices from the processing progress statuses of said plurality of devices and processing completion times by product category and by process saved in advance; and
means for predicting the starting times of the setup operation for the devices from the processing completion statuses of said plurality of devices and a time required for the setup operation for processing of the devices saved in advance.

9. The status indication system according to claim 8, wherein said means for predicting processing completion times of said plurality of devices predicts a completion time of processing from a variation distribution of processing time of said plurality of devices.

10. The status indication system according to claim 7, wherein said plurality of devices are testing devices.

11. The status indication system according to claim 7, wherein said means for indicating the locations and the processing progress statuses of said plurality of devices indicates the actual locations of said plurality of devices in scale and the processing progress statuses of said plurality of devices by varying colors or textures of the scaled indication.

12. The status indication system according to claim 7, wherein said means for predicting starting times of the setup operation includes:
means for collectively starting and ending processing of said plurality of devices;
means for uniformly determining the time at which the processing is ended in said set to be collectively processed;
means for conducting ending processing of said set at a certain time from said processing ending time uniformly determined; and
means for calculating the time to start the setup operation for the processing by subtracting the time required for the setup operation for the processing from said starting time of the ending processing.
